(19) United States
(12) Patent Application Publication
(10) Pub. No.: US 2004/0011093 A1
(43) Pub. Date: Jan. 22, 2004

(54) Curved shackle lock

(76) Inventor: Steven A. Fantl, Colgate, WI (US)

Correspondence Address: CALFEE HALTER & GRISWOLD, LLP, 800 SUPERIOR AVENUE, SUITE 1400, CLEVELAND, OH, 44114, US

(21) Appl. No.: 10/290,917

(22) Filed: Nov. 8, 2002

Related U.S. Application Data
(60) Provisional application No. 60/337,957, filed on Nov. 8, 2001.

(51) Int. Cl. E05B 67/06; G05G 5/00; F16H 57/00

(52) U.S. Cl. 70/38 A; 70/53; 70/202

(57) ABSTRACT

A curved shackle gunlock for rendering a gun inoperative from accidental or unauthorized use and for deterring theft. The unique shape of the shackle is critical and will fit most firearms, specifically an automatic rifle. The thickness of the shackle provides maximum protection against destruction and violation. The gunlock can be inserted in the opening of a handgun through the breach and magazine well, through the revolver frame, through the loading port of a shotgun, or through the magazine well of a specialty gun.

### CROSS-REFERENCE TO RELATED APPLICATIONS

This invention claims priority to U.S. Provisional Patent Application Serial No. 60/337,957, filed Nov. 8, 2001.

### FIELD OF THE INVENTION

The invention relates to a lock with a curved shackle, and more specifically to a lock with a shackle with a radius of curvature that allows the lock to secure a firearm to render it inoperative.

### BACKGROUND OF THE INVENTION

Serious injuries resulting from the unauthorized use of firearms is a serious issue facing modem society. Such unauthorized use can result from children playing with guns or from the theft and subsequent use of a gun. Gun security is not only in issue in the home, but also for the police, military, and federal agencies, such as the Federal Bureau of Investigation.

In an attempt to overcome the problems with unauthorized and accidental use of firearms, various existing locks have demonstrated shortcomings to firearm protection. Trigger lock products allow a firearm to be loaded while locked. A loaded firearm has the potential for accidental discharge. In addition, although trigger locks do restrict movement with a number of spring pins, the design may allow the pins to be manipulated back allowing the trigger lock to be moved. Any movement of the trigger lock by manipulation or even excessive force could allow a loaded firearm to be discharged. Cable lock products are restricted in the size of the cable and cable ends, especially when they are required to pass through the gun chamber or breach. The limited size of the cable, along with the limited strength afforded to such cable locking products, may make a cable gun lock susceptible to defeat by pliers, visegrips, or cutting tools.

An additional problem with existing firearm locks is that they typically do not conform or accommodate all weapons, in particular specialty guns or automatic rifles.

### SUMMARY OF THE INVENTION

The present invention relates to a locking device rendering a gun inoperative, and more particularly to a gun lock with a curved shackle that can be inserted in an opening of an unloaded gun and then secured to a lock body with a locking mechanism.

In one embodiment, the gunlock includes a shackle with a toe end and a heel end. The toe end and the heel end curve in an arcuate shape in the same direction.

The present invention further relates to a method for locking an automatic rifle by inserting a lock containing a curved shackle through an exiting port of the automatic rifle. The toe end of the shackle is maneuvered through the exit port and down through the magazine well. The toe end of the shackle can then be inserted into the body of the gunlock and secured by a locking mechanism.

### BRIEF DESCRIPTION OF THE DRAWINGS

The curved shackle lock of the present invention may be more readily understood by reference to the following drawings. While certain embodiments are shown as illustrative examples of the curved shackle lock, the scope of this application should not be construed as limited to these illustrative examples.

FIG. 1A is a perspective view of a curved shackle gunlock of the present invention;

FIG. 1B is a side view of a curved shackle gunlock of the present invention;

FIG. 2 is a front view of a gunlock in an unlocked position;

FIGS. 3-6 are perspective views of a curved shackle gunlock as applied to different types of firearms.

### DETAILED DESCRIPTION OF THE INVENTION

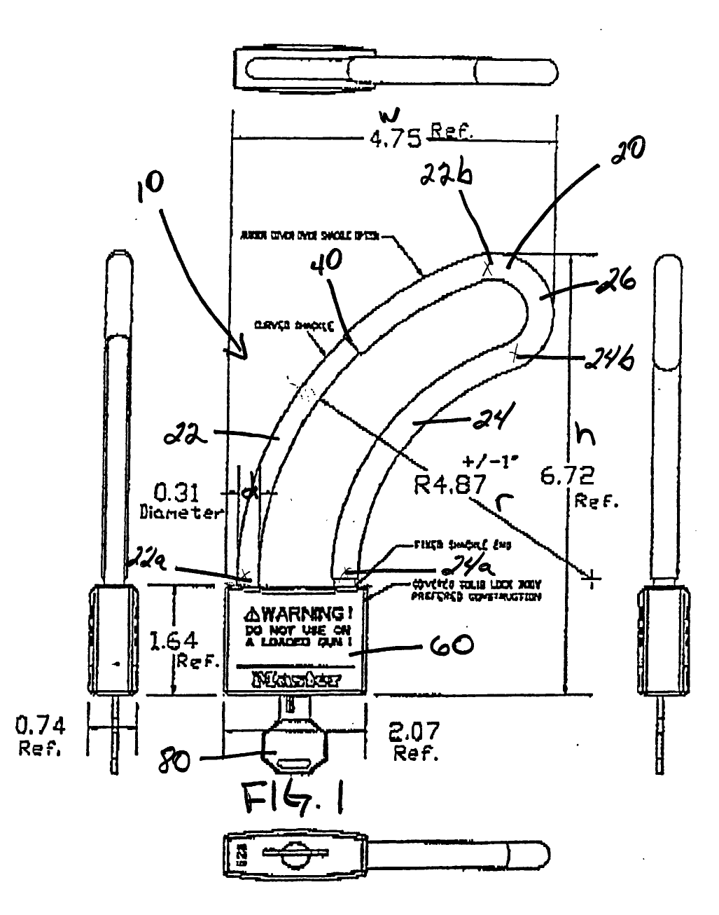

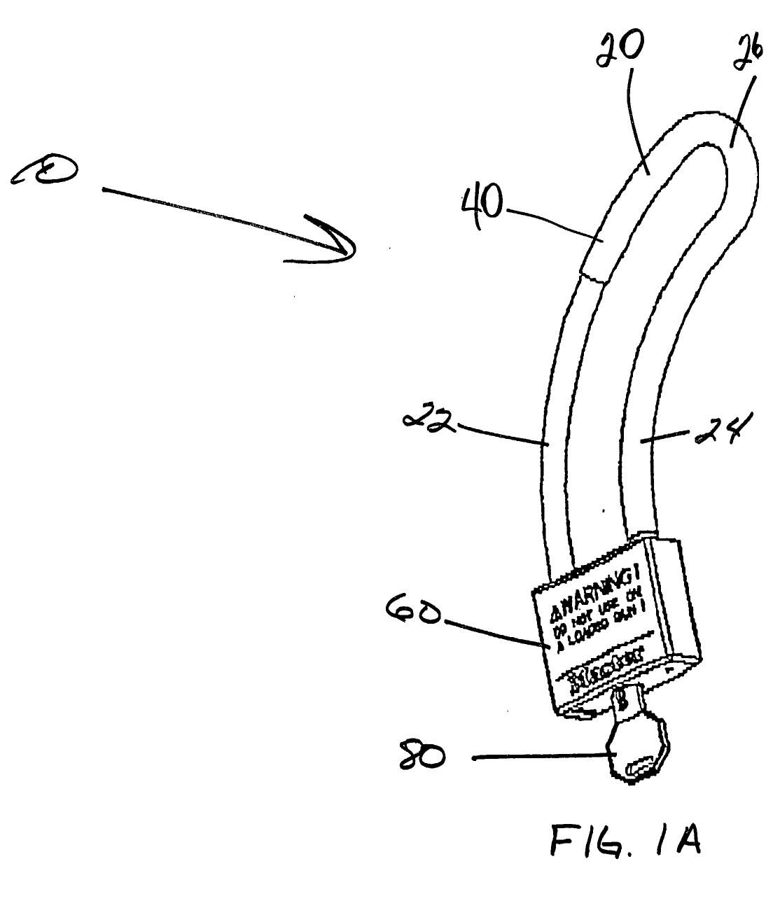

FIG. 1A and 1B shows a curved shackle gunlock 10 in a locked position. The gunlock 10 comprises a unique curved shackle 20 with an option rubber cover 40. The shackle 20 has two ends, a toe end 22 and a heel end 24, each having a bottom and top portion 22a, 22b and 24a, 24b, respectively.

The diameter d of the shackle 20 is maximized to provide the most protection against attempts to defeat the lock, while at the same time allowing for the shackle 20 to pass through various parts of a gun. In one specific embodiment, the shackle diameter d is about 0.31 inches. It should be appreciated by one in the art that this diameter may be in a range of measurements that provide ample security while still allowing for manipulation through the gun as discussed below.

The shackle 20 is curved in a generally arcuate manner, with the heel end 24 and toe end 22 forming portions of concentric circles. The radius of curvature of the shackle r is designed such that the gunlock will accommodate most applications. The toe end 22 has a radius r between about 3.8 inches and about 5.9 inches, and preferably between about 4.62 inches and about 5.12 inches, and more preferably about 4.87 inches.

Both ends of the shackle 20 curve is the same direction concentrically. The top 22b of the toe end 22 converges towards the top 24b of the heel end 24 in an arcuate path. The top 24b of the heel end 24 converges toward the top 22b of the toe end 22 in an arcuate path. As the tops 22b, 24b of the two ends 22, 24 converge to form a solid shackle 20, a rounded shackle top 26 is created. The height of the shackle 20 is approximately 5.08 inches. It should be appreciated by one skilled in the art that these dimensions may be altered as the radius of curvature of the shackle is modified to meet the desired fit within a specific firearm. The shackle is preferably made from a hardened steel or another material that has similar resistance to being sawed.

An option rubber cover 40 may be provided to preserve and protect the shackle 20 and the gun to which the gunlock 10 is applied, from damage. The cover 40 can be place partially or entirely over the shackle 20.

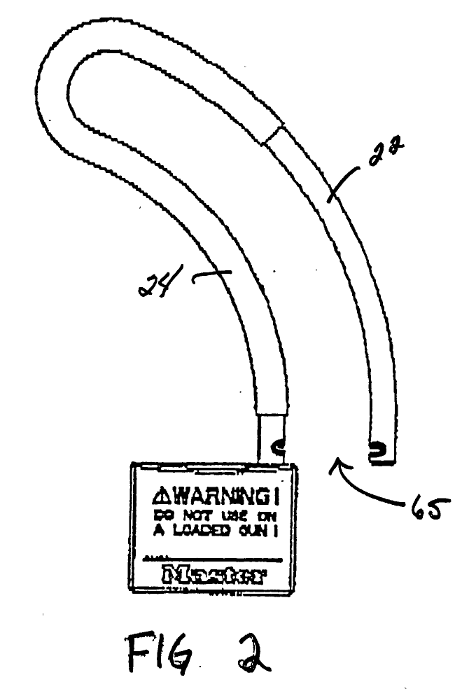

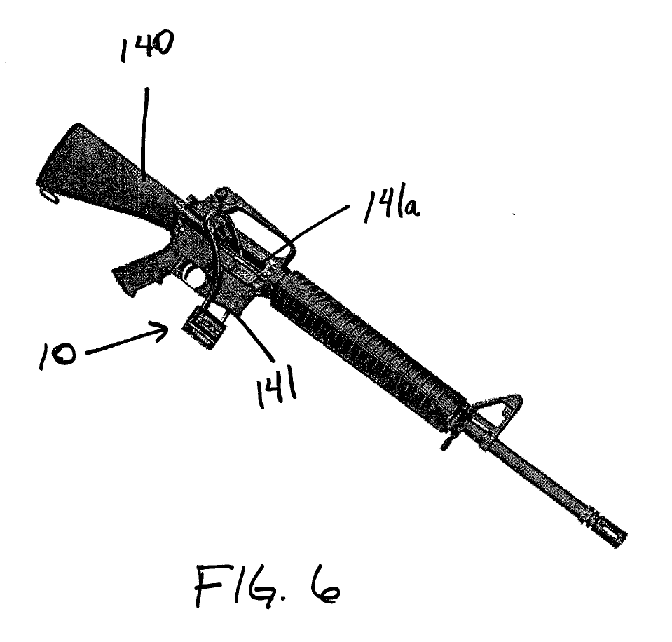

The bottom 22a of the toe end 22 of the shackle can be removed from lock body 60, after key 80 has been inserted and the lock mechanism has been disengaged, to created an unlocked position, as shown in FIG. 2. In the unlocked position, the heel end 24 of the shackle 20 is rotatable within the lock body 60. The toe end 2 is able to swing out beyond the lock body 60 creating an open gap 65 which allows the bottom 22a of the tow end 22 to be placed though an exit port 141a and down a magazine will 141 on a specialty gun or automatic rifle 140, as shown in FIG. 6. One skilled in the art should appreciate that the curvature in the shackle permits the insertion of the lock in this manner. After insertion, the bottom 22a of the toe end 22 is returned to the lock body 60 and the locking mechanism is engaged. In the locked position, part of the firearm is held between the heel end 24 and the toe end 22 of the shackle 20.

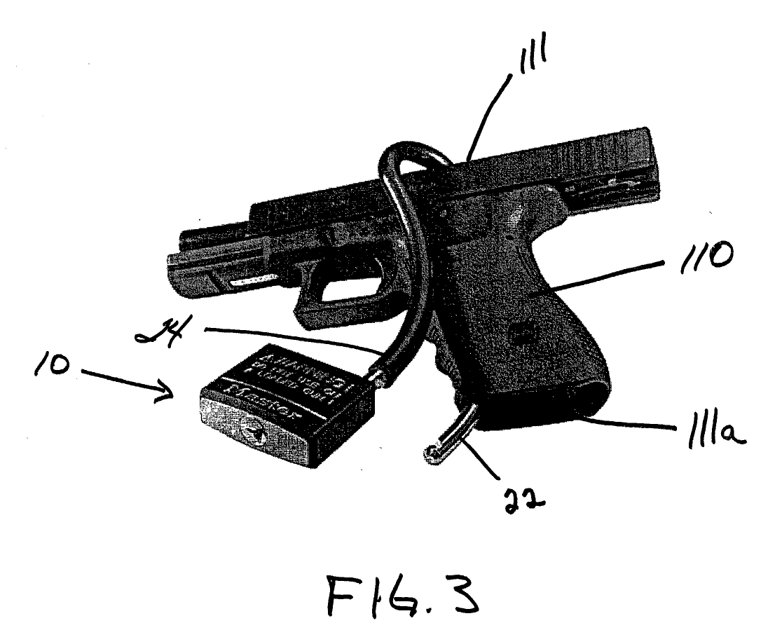

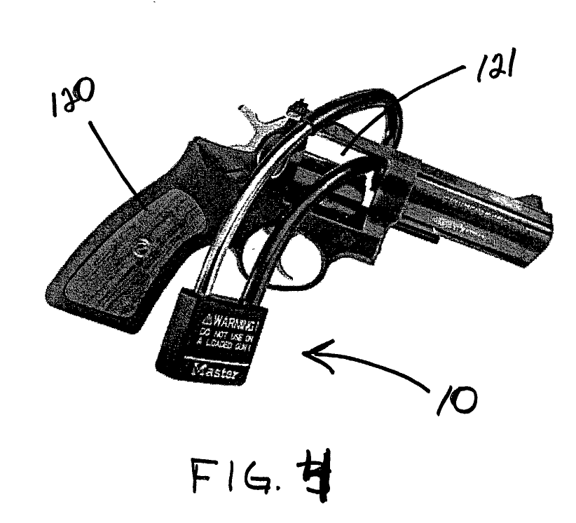

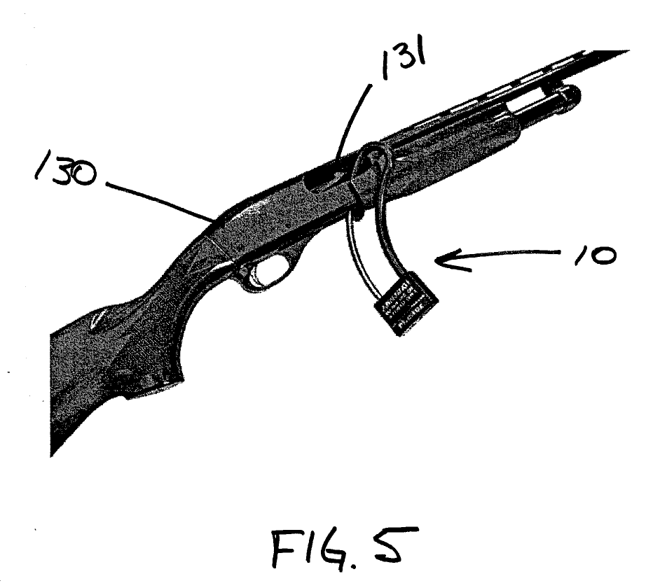

In addition, the gunlock may be placed through an opening in the breach 111 and the magazine well 111a of a semi-automatic handgun 110, as shown in FIG. 3, through the frame 121 of a revolver 120, as shown in FIG. 4, or through the loading port 134 on a shotgun 130, as shown in FIG. 5. As such, a gunlock with a curved shackle as described above can fit the specialized use in an automatic rifle, while also provided security for a vast number of other guns.

Although the present invention has been described in detail with reference to certain preferred embodiments thereof, other embodiments that are within the scope of the claims should be considered as part of this application. Therefore, the spirit and scope of the appended claims should not be limited to the description of the preferred embodiments contained herein.

1. A locking device for rendering a gun inoperative comprising:
a curved shackle able to be inserted in an opening of an unloaded gun; and
a lock body which houses a portion of said curved shackle.

2. The locking device according to claim 1 wherein said curved shackle comprises a toe end and a heel end.

3. The locking device according to claim 2 wherein said toe end and said heel end each have a bottom and a top.

4. The locking device according to claim 3 wherein both said toe end and said heel end curve in the same direction concentrically.

5. The locking device according to claim 4 wherein said top of said toe end converges towards said top of said heel end and wherein said top of said heel end converges towards said top of said toe end.

6. The locking device according to claim 5 wherein said toe end and said heel end join together to create a round top solid shackle.

7. The locking device according to claim 6 wherein said toe end has a radius between 3.8 inches and 5.9 inches.

8. The locking device according to claim 7 wherein said curved shackle has a diameter of at least 0.31 inches.

9. The locking device according to claim 1 further comprising a rubber cover placed over at least a portion of said curved shackle.

10. A gunlock comprising:
a shackle having a toe end and heel end, wherein said toe end and said heel end curve in an arcuate shape in the same direction; and
a lock body with a locking mechanism connected to said shackle.

11. The gunlock according to claim 10 wherein said toe end and said heel end each have a bottom and a top.

12. The gunlock according to claim 11 wherein said toe end and said heel end curve in the same direction concentrically.

13. The gunlock according to claim 12 wherein said top of said toe end converges towards said top of said heel end and wherein said top of said heel end converges towards said top of said toe end.

14. The gunlock according to claim 13 wherein said toe end and said heel end join together to create a round top solid shackle.

15. The gunlock according to claim 14 wherein said toe end has a radius between 3.8 inches and 5.9 inches.

16. The gunlock according to claim 15 wherein said shackle has a diameter of at least 0.31 inches.

17. The gunlock according to claim 10 further comprising a rubber cover to be placed over at least a portion said curved shackle

18. A method for locking an automatic rifle comprising the steps of:
inserting a lock containing a solid curved shackle comprising a toe end and a heel end through an exit port of said automatic rifle;
maneuvering said toe end of said curved shackle through said exit port of said automatic rifle and down through a magazine well of said automatic rifle; and
inserting said toe end of said curved shackle into a lock body locking said curved shackle, wherein said curved shackle has a radius between 3.8 inches and 5.9 inches.
